(19) United States
(12) Patent Application Publication
(10) Pub. No.: US 2004/0074332 A1
(43) Pub. Date: Apr. 22, 2004

(54) Handlebar assembly of bicycles

(76) Inventor: Cheng-Xun Jiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/274,899

(22) Filed: Oct. 22, 2002

(51) Int. Cl. B62K 21/12

(52) U.S. Cl. 74/551.1

(57) ABSTRACT

A handlebar assembly for bicycles includes a connection bar having a first end securely mounted to a steerer tube and a recess is defined in a second end of the connection bar. A positioning cap has a concavity defined in an underside thereof and is securely connected to the second end of the connection bar. A pad is connected to an inside of the concavity of the positioning cap and a handlebar is securely engaged with the concavity of the positioning cap and the recess of the connection bar. Bolts extend through the positioning cap, the pad and are threadedly engaged with threaded holes defined in the connection bar.

### FIELD OF THE INVENTION

The present invention relates to a handlebar assembly for bicycles and includes a pad connected to an inside of a positioning cap made of compound material, screws extending through the positioning cap and the pad to position the handlebar. The pad reinforces the structural strength of the positioning cap.

### BACKGROUND OF THE INVENTION

A conventional handlebar assembly for bicycles generally includes a connection bar which has one end thereof fixed to the steerer tube and the other end of the connection bar is connected to the handlebar. It is a trend that a modern handlebar assembly is designed to be more personality and light in weight by using compound material which is light, durable and never get rust. The handlebar is securely positioned by using bolts to extend through the part that is made by compound material. Nevertheless, the compound material tends to be broken when it is drilled holes and bolts extend through the part. In other words, the compound material made part cannot be used at some positions where large stress is applied.

The present invention intends to provide a pad which is connected to an inside of the compound material made positioning cap such that the positioning cap is not broken when bolts extend through it.

### SUMMARY OF THE INVENTION

In accordance with one aspect of the present invention, there is provided a handlebar assembly for bicycles and the assembly comprises a connection bar with a first end thereof securely mounted to a steerer tube and a recess is defined in a second end of the connection bar so that a handlebar is engaged with the recess and a positioning cap is connected to the second end of the connection bar to securely clamp the handlebar in place. The positioning cap has a concavity defined in an underside thereof and a pad is connected to an inside of the concavity of the positioning cap. Bolts extend through the positioning cap, the pad and are threadedly engaged with threaded holes defined in the connection bar.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the handlebar assembly of the present invention;

FIG. 2 is an exploded view to show the handlebar assembly of the present invention;

FIG. 3 is a cross sectional view to show the handlebar assembly of the present invention;

FIG. 4 shows another embodiment of the handlebar assembly of the present invention, and

FIG. 5 shows yet another embodiment of the handlebar assembly of the present invention.

### DETAILED DESCRIPTION OF THE PREFERRED EMBODIMENT

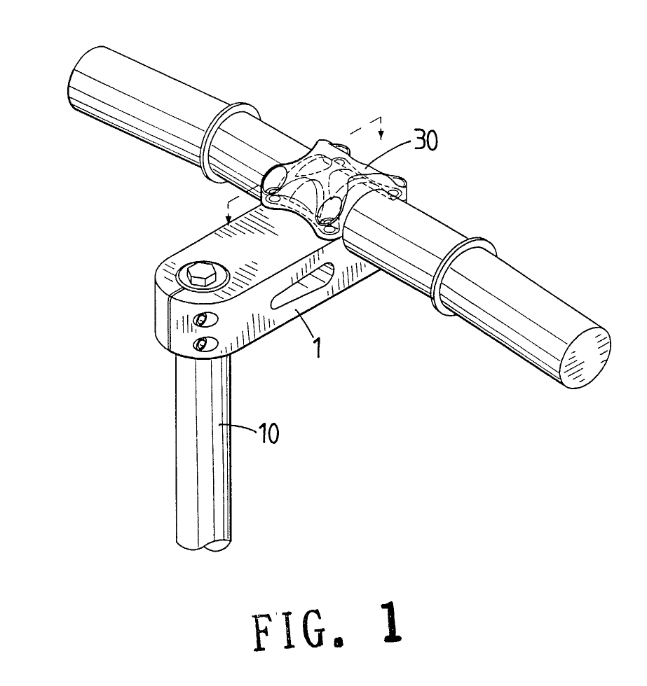

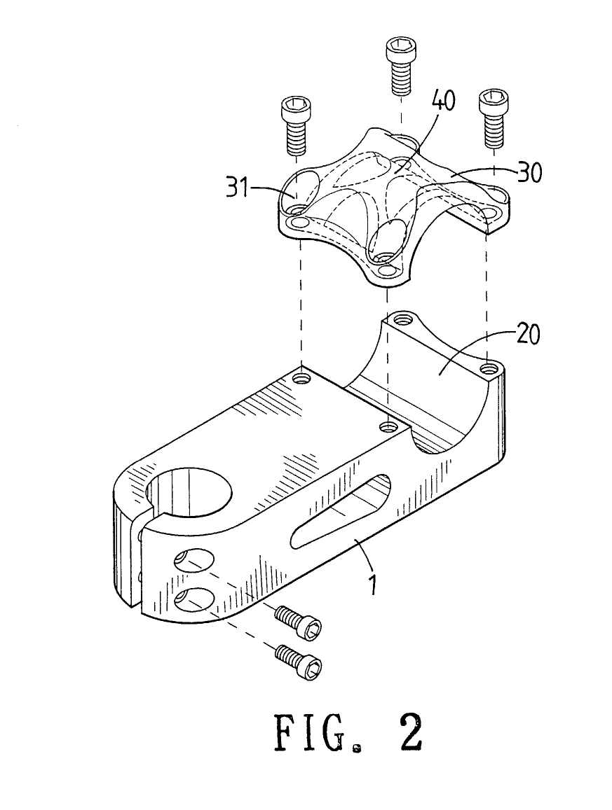

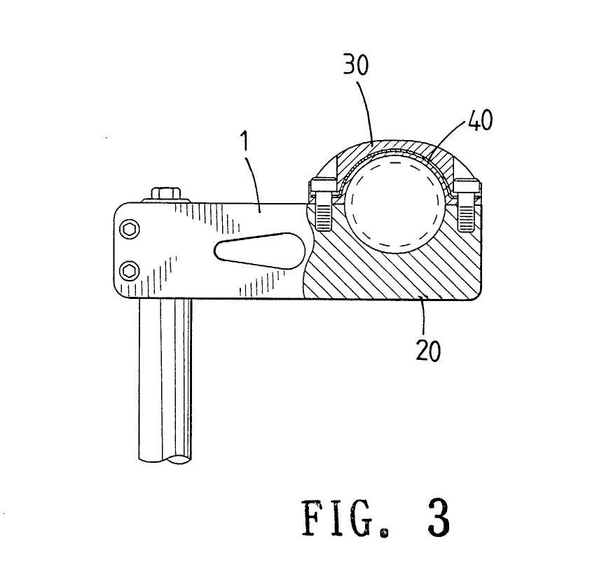

Referring to FIGS. 1 to 3, the handlebar assembly of the present invention comprises a connection bar 1 having a first end with a C-shaped opening in which a steerer tube 10 is securely received by extending bolts through the first end of the connection bar 1 to narrow the C-shaped opening. A recess 20 is defined in a second end of the connection bar 1 and four threaded holes are defined on two sides of the recess 20.

A positioning cap 30 has a concavity defined in an underside thereof and four sink holes 31 are defined through four corners thereof. Bolts extend through the four sink holes 31 and are threadedly engaged with the four threaded holes in the second end of the connection bar 1.

A pad 40 is connected to an inside of the concavity of the positioning cap 30 and a handlebar is securely engaged with the concavity of the positioning cap 30 and the recess 20 of the connection bar 1. The handlebar is securely positioned by the bolts securely connecting the positioning cap 30 to the connection bar 1.

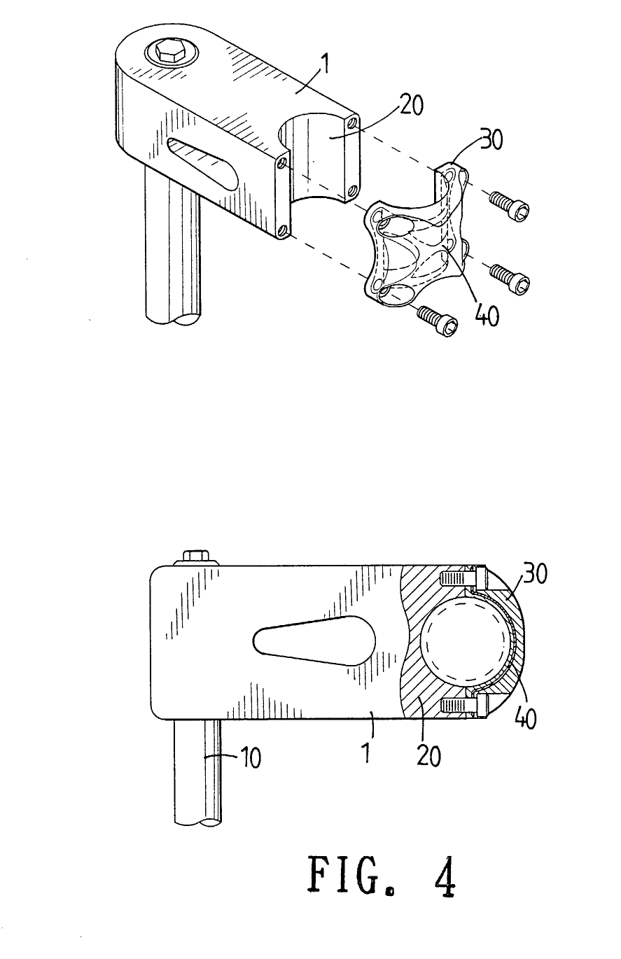

The positioning cap 30 is made by compound material such as carbon-fiber and the pad 40 is made of plastic material or metal. Holes can be made through the pad 40 so that it has proper flexibility and can absorb stress when the bolts extend through the positioning cap 30 and the pad 40 by deformation. FIG. 4 shows that the recess 20 can be made at the end face of the second end of the connection bar 1.

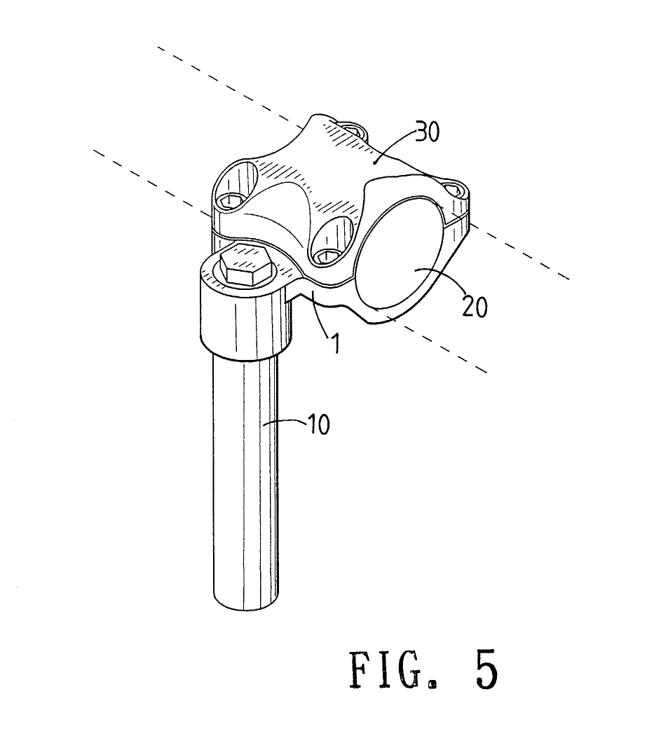

FIG. 5 shows that the connection bar 1 is simplified to be a short part and the handlebar is positioned close to the steerer tube 10.

While we have shown and described the embodiment in accordance with the present invention, it should be clear to those skilled in the art that further embodiments may be made without departing from the scope of the present invention.

What is claimed is:

1. A handlebar assembly for bicycles, comprising:
a connection bar having a first end adapted to be securely mounted to a steerer tube, a recess defined in a second end of the connection bar, a positioning cap having a concavity defined in an underside thereof and securely connected to the second end of the connection bar, and
a pad connected to an inside of the concavity of the positioning cap and a handlebar securely engaged with the concavity of the positioning cap and the recess of the connection bar, bolts extending through the positioning cap, the pad and threadedly engaged with threaded holes defined in the connection bar.

2. The assembly as claimed in claim 1, wherein the positioning cap has four sink holes defined through four corners thereof and the bolts extend through the four sink holes.
